(19) United States
(12) Patent Application Publication
(10) Pub. No.: US 2025/0166274 A1
(43) Pub. Date: May 22, 2025

(54) SYSTEMS AND METHODS FOR GESTURE GENERATION

(71) Applicant: Datum Point Labs Inc., Jackson, WY (US)

(72) Inventors: Seonghyeok Noh, Seoul (KR); Hanseok Ko, Seoul (KR); Bonhwa Ku, Seoul (KR)

(21) Appl. No.: 18/953,359

(22) Filed: Nov. 20, 2024

Related U.S. Application Data
(60) Provisional application No. 63/602,176, filed on Nov. 22, 2023.

(51) Int. Cl. G06T 13/40

(52) U.S. Cl. CPC G06T 13/40

(57) ABSTRACT

Embodiments described herein include a hybrid gesture generation model using a sentence encoder. By using a pre-trained model as the sentence encoder, the framework may output an embedding for a sentence containing any word, even if it is not in the training set, Further, embodiments described herein include a hybrid gesture model that combines trained co-speech gesture generation with a retrieval of pre-defined special gestures. The generation part uses text input to a model trained with co-speech gesture data. The retrieval part uses pre-defined gestures for six different situations that have been prepared in advance. Using embodiments described herein, an AI avatar can perform special gestures like greeting or shaking hands in predefined specific situations, and co-speech gestures in other conversational situations.

### TECHNICAL FIELD

The embodiments relate generally to systems and methods for gesture generation.

### BACKGROUND

In machine learning, gestures (such as motions of hands, eyes, mouth, etc.) may be generated by a gesture generation model based on an input text or audio. However, most gesture generation methods have two major issues. The first is that they use individual words as input to generate gestures. In this case, any words not used during training are treated the same as they are all unknown to the model. This means completely different words could be given the same encoding. The second problem with existing gesture generation methods is that they primarily deal with gestures in lecture or conversation situations and do not address gestures for specific situations such as greeting or shaking hands. Therefore, there is a need for improved systems and methods for gesture generation.

### BRIEF DESCRIPTION OF THE DRAWINGS

FIG. 1A illustrates an exemplary framework for gesture generation, according to some embodiments.

FIG. 1B is a simplified diagram of a co-speech gesture generator, according to some embodiments.

FIG. 2 is a simplified diagram illustrating a computing device implementing the framework described in FIGS. 1A-1B, according to some embodiments.

FIG. 3 is a simplified block diagram of a networked system suitable for implementing the framework described in FIGS. 1A-1B and other embodiments described herein.

### DETAILED DESCRIPTION

In machine learning, gestures (such as motions of hands, eyes, mouth, etc.) may be generated by a gesture generation model based on an input text or audio. However, most gesture generation methods have two major issues.

Current gesture generation systems fail to address words not found in the training set and tend to output only co-speech gestures, which are suitable for competitions or general conversations but not for specific situations. Existing gesture generation methods input text at the word level, index each word, and extract word embedding using a pre-trained model. However, only words in the training set are indexed, so words not in the dictionary are not indexed and thus are considered unknown tokens. Different words are treated as the same unknown token if they are not in the training set, which presents a problem in responding accurately.

Another issue is that gesture generation is appropriate for lecture or conversational situations but not for specific circumstances. A typical example of co-speech gestures can be seen in TED talks, where speakers use gestures while talking. However, there are more appropriate gestures for situations like meeting someone for the first time or agreeing or disagreeing with someone's statement.

Embodiments described herein include a hybrid gesture generation model using a sentence encoder. By using a pre-trained model as the sentence encoder, the framework may output an embedding for a sentence containing any word, even if it is not in the training set, solving the issue of different words using the same input. Further, embodiments described herein include a hybrid gesture model that combines trained co-speech gesture generation with a retrieval of pre-defined special gestures. The generation part uses text input to a model trained with co-speech gesture data. The retrieval part uses pre-defined gestures for six different situations that have been prepared in advance. Using embodiments described herein, an AI avatar can perform special gestures like greeting or shaking hands in predefined specific situations, and co-speech gestures in other conversational situations.

Embodiments described herein provide a number of benefits. For example, embodiments described herein can handle not only words but also sentences as inputs, which mitigates the disadvantages of using only words. By utilizing sentence inputs, embodiments described herein can also employ techniques closely related to sentences, such as measuring sentence similarity. Furthermore, the hybrid approach allows for the generation of both co-speech gestures and special gestures. As a result, more accurate gestures may be generated, without requiring a generation model to be trained on every possible input word, improving efficiency, and reducing memory and/or computation requirements. Uses of embodiments described herein include enhancing expressiveness in human-computer interfaces, and as an effective communication tool for virtual environments.

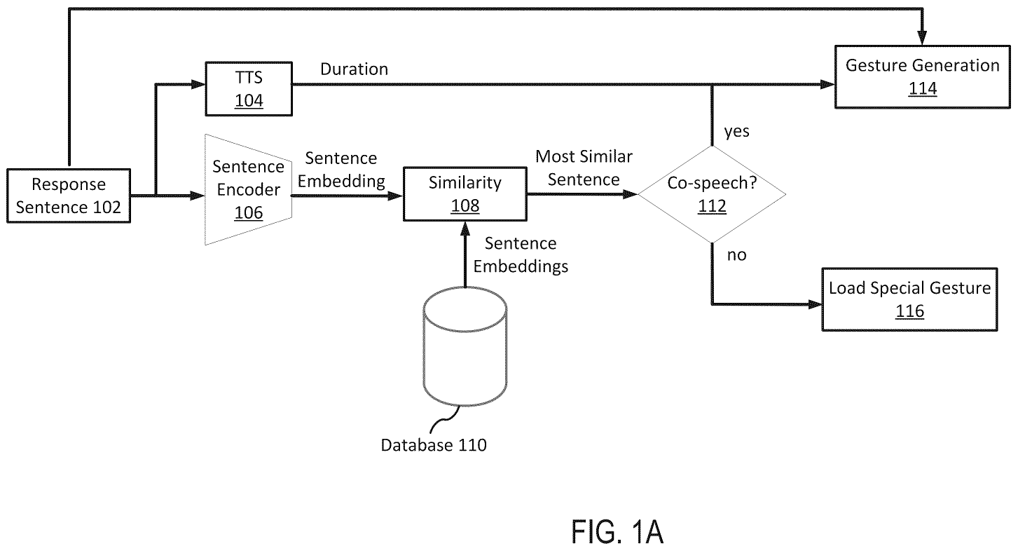

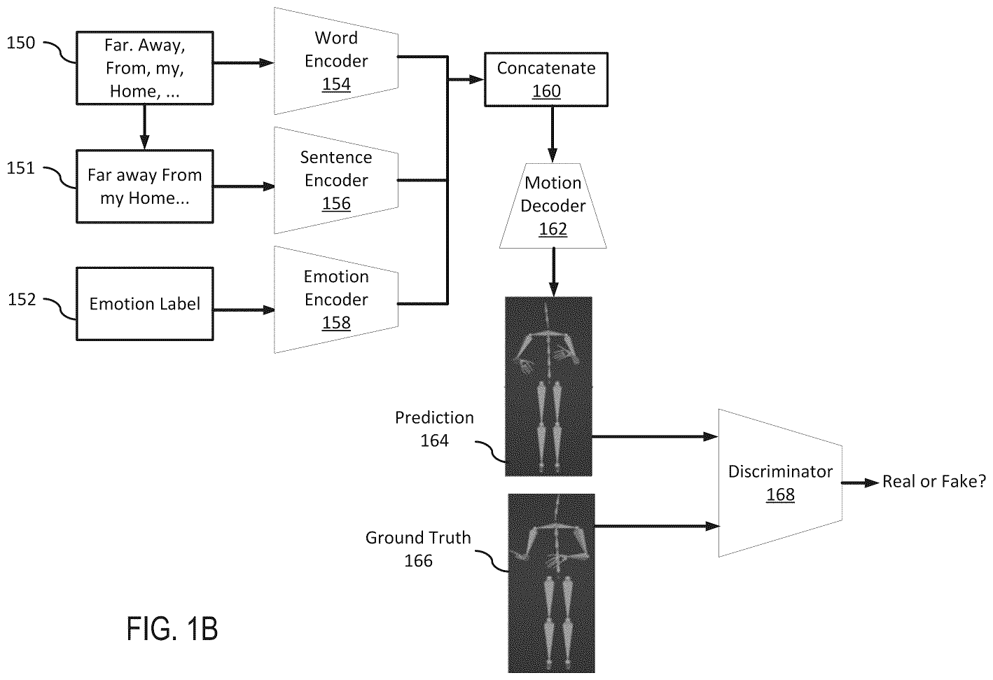

FIG. 1A illustrates an exemplary framework for gesture generation, according to some embodiments. The framework of FIG. 1A may generate a co-speech gesture by inputting sentences, words, and emotions. Further, the framework of FIG. 1A may integrate the co-speech gesture generation model and a predefined special gesture model. The hybrid model therefore has the ability to load special gestures when appropriate, and otherwise generate co-speech gestures according to the input response sentence 102.

A sentence encoder 106 may be configured to receive an input sentence (e.g., a response to a prompt generated by a large language model). When a sentence is input, it passes through a Sentence Encoder to extract sentence embedding. The similarity 108 between the database's sentence embeddings and the input sentence's embedding is calculated to find the closest matching sentence. Depending on what the closest sentence is, it is divided into co-speech gesture generation and special gesture load. The database may include, for example, a collection of sentences (and/or sentence vector embeddings) and associated gestures related to those sentences. For example, the sentence “What?” may be associated with a “shrug” gesture, an the sentence “OK, bye” may be associated with a waving gesture.

The sentence embedding generated by the sentence encoder 106 may be used to retrieve the closest sentence embedding from a database. Based on the closest similarity sentence, a predefined special gesture 116 may be loaded. For this purpose, special gestures of various lengths may be created, and the gesture to be called is determined according to the action of the most similar sentence.

If the framework, at decision 112, determines that the sentence embedding is not related to a special gesture (e.g., the closest embedded sentence in the database is greater than a predetermined threshold distance in the vector space), gesture generation may be performed to generate a co-speech gesture. In some embodiments, a pretrained co-speech gesture generation model 114 generates a gesture based on the response text as input with the determined duration. The length of the motion is determined by the length of the audio resulting from a text to speech (TTS) model 104 based on a TTS generation of the input response sentence 102. Once the co-speech gesture is generated, it is output as the AI avatar's motion. Additional details of co-speech gesture generation are described with respect to FIG. 1B.

FIG. 1B is a simplified diagram of a co-speech gesture generator (e.g., implementing the gesture generation of FIG. 1A), according to some embodiments.

A word encoder 154 extracts features for each word 150 of the input sentence 151. As words come in, the word encoder 154 performs an indexing process to extract the index of each word and uses a pre-trained model for word embedding. If a word is not in the training set and an index cannot be assigned, it is treated as an unknown token and the word embedding process begins. In other words, even if they are different words, if both do not have an index number, they are treated as the same unknown token.

A sentence encoder 156 (e.g., the sentence encoder 106 of FIG. 1A) in some embodiments is a pre-trained model that takes the input sentence 151 to extract a sentence embedding. Similar sentences will have similar embedding values. These results can be used to determine sentence similarity. By introducing a sentence encoder 156 in addition to the word encoder 154, it becomes possible to make distinctions over words not in the training corpus for the word encoder.

An emotion encoder 158 may take an input emotion label 152 and extract an emotion embedding. Emotions may include, for example, neutral, sadness, happiness, anger, fear, disgust, contempt, and surprise.

The results of the emotion encoder 158 are concatenated and input into the motion decoder. Concatenation 160 may concatenate the results of the word encoder 154, sentence encoder 156, and/or emotion encoder 158. The motion decoder 162 outputs a sequence of co-speech gestures (e.g., prediction 164).

A discriminator 168 is trained to distinguish between gestures generated by the motion decoder (e.g., prediction 164) and actual gestures (e.g., ground truth 166). This structure is used to train the motion decoder's output to be indistinguishable from real gestures.

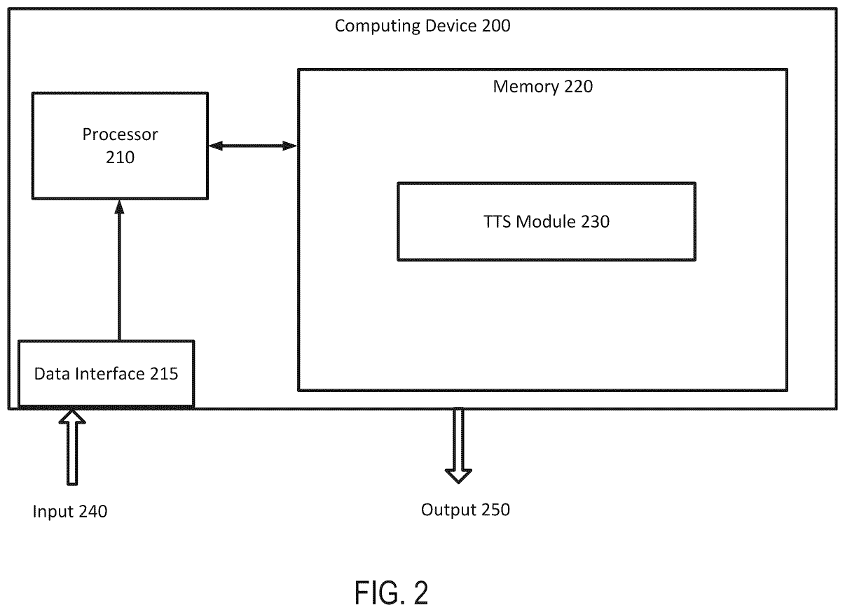

FIG. 2 is a simplified diagram illustrating a computing device 200 implementing the framework described in FIGS. 1A-1B, according to some embodiments. As shown in FIG. 2, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for gesture generation module 230 that may be used to implement and/or emulate the systems and models, and/or to implement any of the methods described further herein. Gesture generation module 230 may receive input 240 such as Audio input, text input, and/or emotion selection input and generate an output 250 which may be a generated gestures.

The data interface 215 may comprise a communication interface, a user interface (such as a voice input interface, a graphical user interface, and/or the like). For example, the computing device 200 may receive the input 240 from a networked device via a communication interface. Or the computing device 200 may receive the input 240, such as images, from a user via the user interface.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

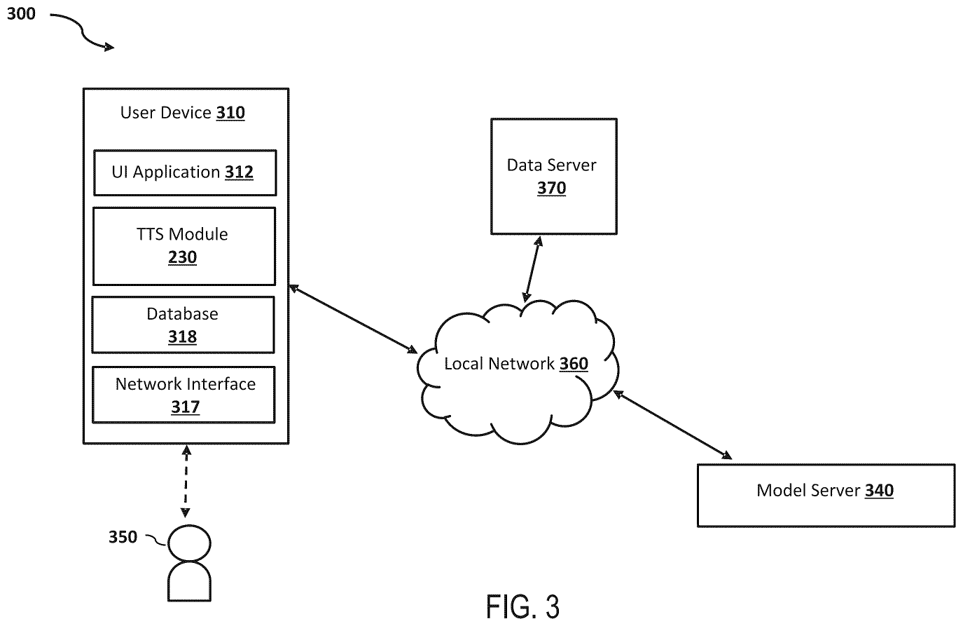

FIG. 3 is a simplified block diagram of a networked system 300 suitable for implementing the framework described in FIGS. 1A-1B and other embodiments described herein. In one embodiment, system 300 includes the user device 310 (e.g., computing device 200) which may be operated by user 350, data server 370, model server 340, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2, operating an OS such as a MICROSOFT® OS, a UNIX® OS, a LINUX® OS, or other suitable device and/or server-based OS. It can be appreciated that the devices and/or servers illustrated in FIG. 3 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

User device 310, data server 370, and model server 340 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over local network 360.

In some embodiments, all or a subset of the actions described herein may be performed solely by user device 310. In some embodiments, all or a subset of the actions described herein may be performed in a distributed fashion by various network devices, for example as described herein.

User device 310 may be implemented as a communication device that may utilize appropriate hardware and software configured for wired and/or wireless communication with data server 370 and/or the model server 340. For example, in one embodiment, user device 310 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE® or any other appropriate device. Although only one communication device is shown, a plurality of communication devices may function similarly.

User device 310 of FIG. 3 contains a user interface (UI) application 312, and gesture generation module 230, which may correspond to executable processes, procedures, and/or applications with associated hardware. For example, the user device 310 may allow a user to input text for gesture generation, or otherwise interact with a system which automatically generates text (e.g., a chat agent). In other embodiments, user device 310 may include additional or different modules having specialized hardware and/or software as required.

In various embodiments, user device 310 includes other applications as may be desired in particular embodiments to provide features to user device 310. For example, other applications may include security applications for implementing client-side security features, programmatic client applications for interfacing with appropriate application programming interfaces (APIs) over local network 360, or other types of applications. Other applications may also include communication applications, such as email, texting voice, social networking, and IM applications that allow a user to send and receive emails, calls, texts, and other notifications through local network 360.

Local network 360 may be a network which is internal to an organization, such that information may be contained within secure boundaries. In some embodiments, local network 360 may be a wide area network such as the internet. In some embodiments, local network 360 may be comprised of direct connections between the devices. In some embodiments, local network 360 may represent communication between different portions of a single device (e.g., a network bus on a motherboard of a computation device).

Local network 360 may be implemented as a single network or a combination of multiple networks. For example, in various embodiments, local network 360 may include the Internet or one or more intranets, landline networks, wireless networks, and/or other appropriate types of networks. Thus, local network 360 may correspond to small scale communication networks, such as a private or local area network, or a larger scale network, such as a wide area network or the Internet, accessible by the various components of system 300.

User device 310 may further include database 318 stored in a transitory and/or non-transitory memory of user device 310, which may store various applications and data (e.g., model parameters) and be utilized during execution of various modules of user device 310. Database 318 may store text, audio, gestures, sentence embeddings, special gestures, emotion data, etc. In some embodiments, database 318 may be local to user device 310. However, in other embodiments, database 318 may be external to user device 310 and accessible by user device 310, including cloud storage systems and/or databases that are accessible over local network 360.

User device 310 may include at least one network interface component 317 adapted to communicate with data server 370 and/or model server 340. In various embodiments, network interface component 317 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data Server 370 may perform some of the functions described herein. For example, data server 370 may store sentence embeddings and special gestures, etc.

Model server 340 may be a server that hosts models such as the pre-trained sentence embedding model, or other models described herein. Model server 340 may provide an interface via local network 360 such that user device 310 may perform functions relating to the models as described herein (e.g., generating gestures). Model server 340 may communicate outputs of models via local network 360.

The devices described above may be implemented by one or more hardware components, software components, and/or a combination of the hardware components and the software components. For example, the device and the components described in the exemplary embodiments may be implemented, for example, using one or more general purpose computers or special purpose computers such as a processor, a controller, an arithmetic logic unit (ALU), a digital signal processor, a microcomputer, a field programmable gate array (FPGA), a programmable logic unit (PLU), a microprocessor, or any other device which executes or responds instructions. The processing device may perform an operating system (OS) and one or more software applications which are performed on the operating system. Further, the processing device may access, store, manipulate, process, and generate data in response to the execution of the software. For ease of understanding, it may be described that a single processing device is used, but those skilled in the art may understand that the processing device includes a plurality of processing elements and/or a plurality of types of the processing element. For example, the processing device may include a plurality of processors or include one processor and one controller. Further, another processing configuration such as a parallel processor may be implemented.

The software may include a computer program, a code, an instruction, or a combination of one or more of them, which configure the processing device to be operated as desired or independently or collectively command the processing device. The software and/or data may be interpreted by a processing device or embodied in any tangible machines, components, physical devices, computer storage media, or devices to provide an instruction or data to the processing device. The software may be distributed on a computer system connected through a network to be stored or executed in a distributed manner. The software and data may be stored in one or more computer readable recording media.

The method according to the exemplary embodiment may be implemented as a program instruction which may be executed by various computers to be recorded in a computer readable medium. At this time, the medium may continuously store a computer executable program or temporarily store it to execute or download the program. Further, the medium may be various recording means or storage means to which a single or a plurality of hardware is coupled and the medium is not limited to a medium which is directly connected to any computer system, but may be distributed on the network. Examples of the medium may include magnetic media such as hard disk, floppy disks and magnetic tapes, optical media such as CD-ROMs and DVDs, magneto-optical media such as optical disks, and ROMs, RAMS, and flash memories to be specifically configured to store program instructions. Further, an example of another medium may include a recording medium or a storage medium which is managed by an app store which distributes application, a site and servers which supply or distribute various software, or the like.

Although the exemplary embodiments have been described above by a limited embodiment and the drawings, various modifications and changes can be made from the above description by those skilled in the art. For example, even when the above-described techniques are performed by different order from the described method and/or components such as systems, structures, devices, or circuits described above are coupled or combined in a different manner from the described method or replaced or substituted with other components or equivalents, the appropriate results can be achieved. It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method of gesture generation, comprising:
generating a sentence embedding via a sentence encoder based on an input sentence;
determining a similarity of the sentence embedding to a plurality of sentence embeddings, wherein the plurality of sentence embeddings are associated with respective special gestures;
performing, based on the similarity, at least one of:
generating a co-speech gesture based on the sentence embedding; or
loading a special gesture; and
causing the co-speech gesture or the special gesture to be performed by a virtual avatar.
